(19) United States
(12) Patent Application Publication
(10) Pub. No.: US 2017/0250941 A1
(43) Pub. Date: Aug. 31, 2017

(54) GENERATING ENHANCED CONTENT

(71) Applicant: theSkimm, New York, NY (US)

(72) Inventors: Danielle Weisberg, New York, NY (US); Carly Zakin, New York, NY (US); Dheerja Kaur, Brooklyn, NY (US)

(21) Appl. No.: 15/441,543

(22) Filed: Feb. 24, 2017

Related U.S. Application Data
(60) Provisional application No. 62/299,689, filed on Feb. 25, 2016.

(51) Int. Cl. H04L 12/58; H04L 29/08

(52) U.S. Cl. CPC H04L 51/32; H04L 67/02

(57) ABSTRACT

Implementations of the disclosure provide a method comprising receiving a content item. The content item is processed to retrieve content relevant to the content item from a third-party content source. One or more enhanced content items are generated based on the content item and the retrieved content relevant to the content item. At least one of the one or more enhanced content items is provided to a user device based on one or more characteristics of the user device.

### CROSS REFERENCE TO RELATED APPLICATION

This application claims the benefit of U.S. Provisional Application No. 62/299,689, filed Feb. 25, 2016, the entire disclosure of which is incorporated herein by this reference.

### TECHNICAL FIELD

The present disclosure is generally related to the targeting for digital content, and more specifically, to generating enhanced content.

### BACKGROUND

The Internet has enabled access to a wide variety of content items, e.g., text, graphics, audio and/or video files, web pages for particular subjects, news articles, etc. Such access to these content items has likewise enabled opportunities for targeted content delivery.

### BRIEF DESCRIPTION OF THE DRAWINGS

The present disclosure is illustrated by way of example, and not by way of limitation, and can be more fully understood with reference to the following detailed description when considered in connection with the figures as described below.

FIG. 1A depicts an illustrative system architecture in accordance with one implementation of the present disclosure.

FIG. 1B depicts an exemplary implementation of the described technologies.

FIG. 2 depicts one exemplary implementation of user device in accordance with one implementation of the present disclosure.

FIG. 3 depicts an illustrative computer system in accordance with one implementation of the present disclosure.

FIG. 4 depicts an exemplary flow diagram showing a method of generating enhanced content in accordance with one implementation of the present disclosure.

FIGS. 5A-5B depicts an exemplary user interface in accordance with implementations of the present disclosure.

FIG. 6 depicts an exemplary user interface of a mobile application in accordance with implementations of the present disclosure

FIG. 7 depicts an exemplary user interface of a web browser in accordance with implementations of the present disclosure

FIG. 8 depicts an exemplary calendar entry in accordance with implementations of the present disclosure

FIG. 9 depicts an exemplary social media post in accordance with implementations of the present disclosure

FIG. 10 depicts a content item in accordance with implementations of the present disclosure.

FIG. 11 depicts an exemplary notification in accordance with implementations of the present disclosure.

### DETAILED DESCRIPTION

Aspects and implementations of the present disclosure are directed to generating enhanced content. The systems and methods disclosed can be applied to digital media content such as emails, electronic messages, web pages, digital media (e.g., images, video, etc.), social media posts, mobile content, notifications, calendar entries, etc. such as can be provided to and/or accessed by various electronic and/or mobile computing devices, laptop/desktop computers, etc. More particularly, it can be appreciated that while media organizations utilize content management systems (“CMS”) in order to enable editorial staff to create content and deliver such content (e.g., to a website, mobile application, etc.), it may be advantageous in certain scenarios to disseminate such content (and/or variations thereof) in other formats (e.g., as calendar entries, notifications, social media posts, etc.).

Accordingly, described herein are technologies that enable content creators (e.g., members of an editorial team) to create one piece of content (e.g., a blog post, social media post, article, etc.) and convert such a single piece of content into multiple formats that can be distributed, for example, web, mobile, social media, notification, messaging, calendar, and other applications. Additionally, in certain implementations the described technologies can enhance the provided content with metadata and/or other information, such as may be obtained by crawling the web, from other third-party content sources, etc.

At this juncture it should be understood that various implementations of the disclosed technologies provide numerous advantages and improvements upon conventional approaches. As noted, while existing technologies may enable a content creator to create and publish content via certain platform, such technologies do not effectively enable the conversion of such content into multiple content formats. Additionally, the described technologies enable such content to be further enhanced with additional information/metadata, such as may not be a part of the original content item. Moreover, as described herein, the described technologies enable such enhanced content items to be delivered to certain users, such as those with respect to which such enhanced content items can be determined to be particularly relevant.

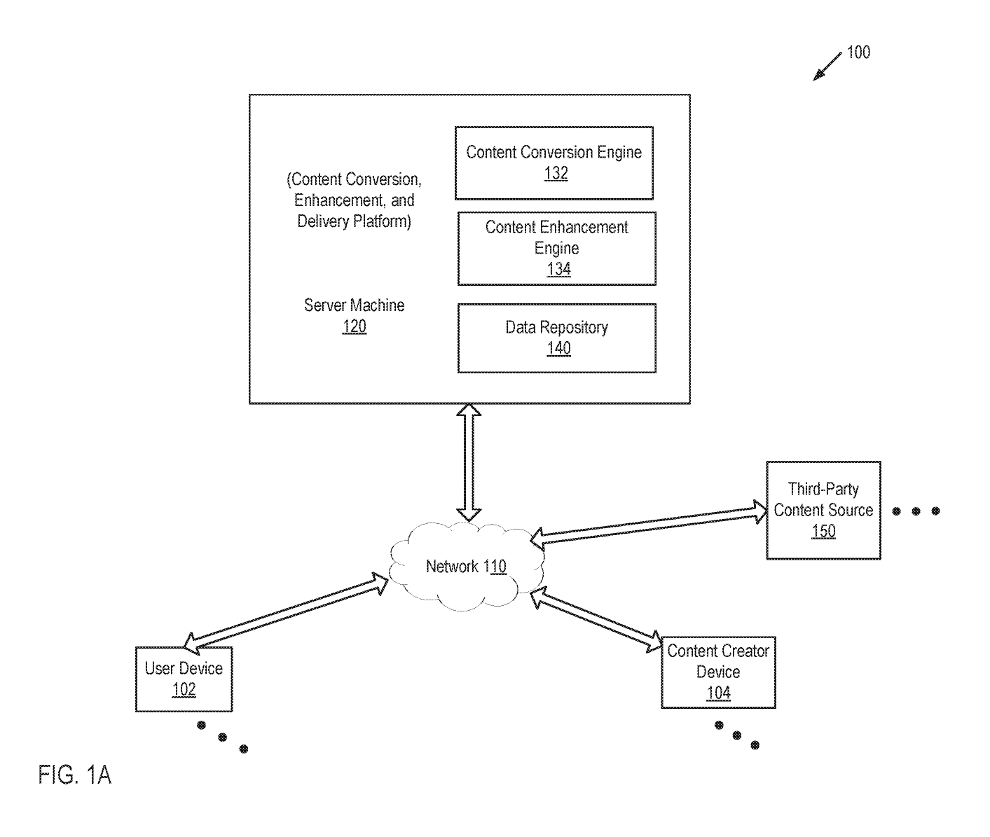

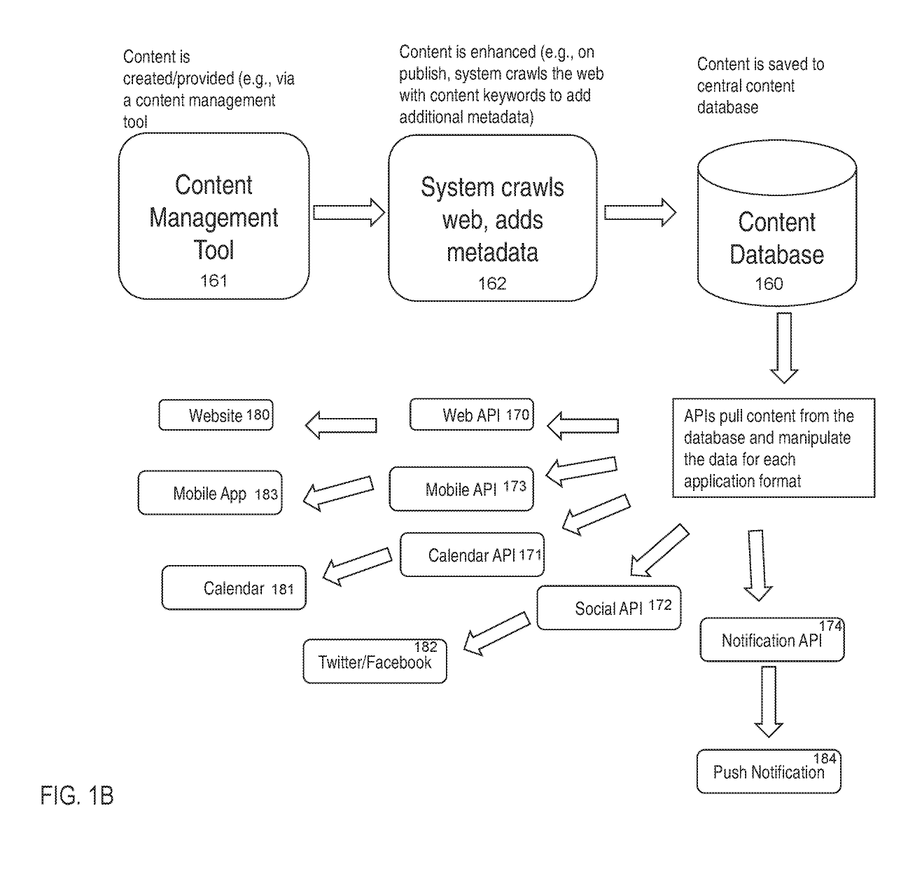

FIG. 1A depicts an illustrative system architecture 100, in accordance with one implementation of the present disclosure. The system architecture 100 includes one or more user device(s) 102, content creator device(s) 104, server machine 120, and third-party content source(s) 150. These various elements or components can be connected to one another via network 110, which can be a public network (e.g., the Internet), a private network (e.g., a local area network (LAN) or wide area network (WAN)), or a combination thereof. Additionally, in certain implementations various elements may communicate and/or otherwise interface directly with one another.

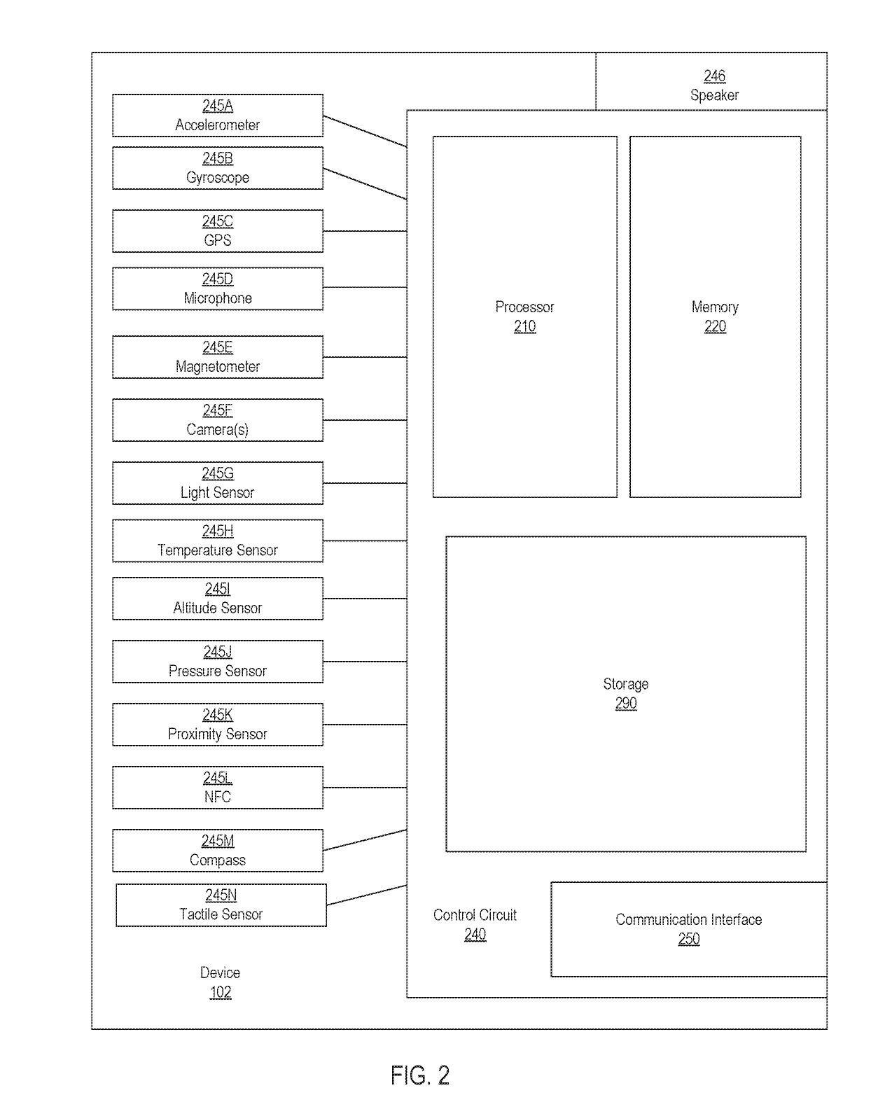

User device 102 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’), web browsers, etc. (not shown) may run on the user device (e.g., on the operating system of the user device). It should be understood that, in certain implementations, user device 102 can also include and/or incorporate various sensors and/or communications interfaces (including but not limited to those depicted in FIG. 2 and/or described herein). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc.

As noted, in certain implementations, user device(s) 102 can also include and/or incorporate various sensors and/or communications interfaces. By way of illustration, FIG. 2 depicts one exemplary implementation of user device 102. As shown in FIG. 2, device 102 can include a control circuit 240 (e.g., a motherboard) which is operatively connected to various hardware and/or software components that serve to enable various operations, such as those described herein. Control circuit 240 can be operatively connected to processor 210 and memory 220. Processor 210 serves to execute instructions for software that can be loaded into memory 220. Processor 210 can be a number of processors, a multi-processor core, or some other type of processor, depending on the particular implementation. Further, processor 210 can be implemented using a number of heterogeneous processor systems in which a main processor is present with secondary processors on a single chip. As another illustrative example, processor 210 can be a symmetric multi-processor system containing multiple processors of the same type.

Memory 220 and/or storage 290 may be accessible by processor 210, thereby enabling processor 210 to receive and execute instructions stored on memory 220 and/or on storage 290. Memory 220 can be, for example, a random access memory (RAM) or any other suitable volatile or non-volatile computer readable storage medium. In addition, memory 220 can be fixed or removable. Storage 290 can take various forms, depending on the particular implementation. For example, storage 290 can contain one or more components or devices. For example, storage 290 can be a hard drive, a flash memory, a rewritable optical disk, a rewritable magnetic tape, or some combination of the above. Storage 290 also can be fixed or removable.

A communication interface 250 is also operatively connected to control circuit 240. Communication interface 250 can be any interface (or multiple interfaces) that enables communication between user device 102 and one or more external devices, machines, services, systems, and/or elements (including but not limited to those depicted in FIG. 1A and described herein). Communication interface 250 can include (but is not limited to) a modem, a Network Interface Card (NIC), an integrated network interface, a radio frequency transmitter/receiver (e.g., WiFi, Bluetooth, cellular, NFC), a satellite communication transmitter/receiver, an infrared port, a USB connection, or any other such interfaces for connecting device 102 to other computing devices, systems, services, and/or communication networks such as the Internet. Such connections can include a wired connection or a wireless connection (e.g. 802.11) though it should be understood that communication interface 250 can be practically any interface that enables communication to/from the control circuit 240 and/or the various components described herein.

At various points during the operation of described technologies, device 102 can communicate with one or more other devices, systems, services, servers, etc., such as those depicted in FIG. 1A and/or described herein. Such devices, systems, services, servers, etc., can transmit and/or receive data to/from the user device 102, thereby enhancing the operation of the described technologies, such as is described in detail herein. It should be understood that the referenced devices, systems, services, servers, etc., can be in direct communication with user device 102, indirect communication with user device 102, constant/ongoing communication with user device 102, periodic communication with user device 102, and/or can be communicatively coordinated with user device 102, as described herein.

Also connected to and/or in communication with control circuit 240 of user device 102 are one or more sensors 245A-245N (collectively, sensors 245). Sensors 245 can be various components, devices, and/or receivers that can be incorporated/integrated within and/or in communication with user device 102. Sensors 245 can be configured to detect one or more stimuli, phenomena, or any other such inputs, described herein. Examples of such sensors 245 include, but are not limited to, an accelerometer 245A, a gyroscope 245B, a GPS receiver 245C, a microphone 245D, a magnetometer 245E, a camera 245F, a light sensor 245G, a temperature sensor 245H, an altitude sensor 245I, a pressure sensor 245J, a proximity sensor 245K, a near-field communication (NFC) device 245L, a compass 245M, and a tactile sensor 245N. As described herein, device 102 can perceive/receive various inputs from sensors 245 and such inputs can be used to initiate, enable, and/or enhance various operations and/or aspects thereof, such as is described herein.

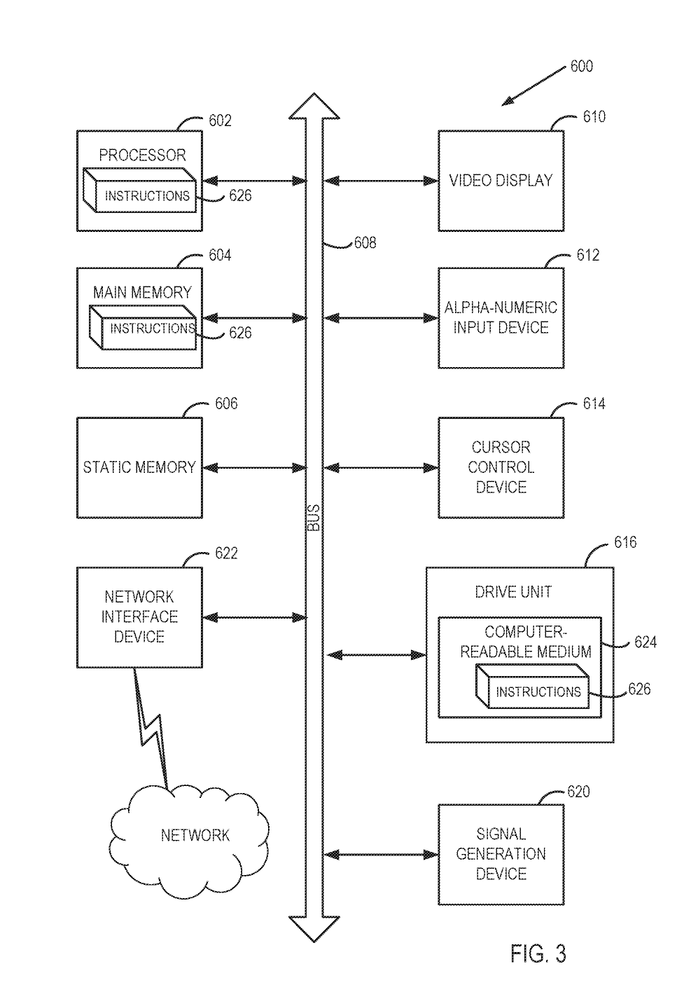

At this juncture it should be noted that while the foregoing description (e.g., with respect to sensors 245) has been directed to user device 102, various other devices, systems, servers, services, etc. (such as are depicted in FIG. 1A and/or described herein) can similarly incorporate the components, elements, and/or capabilities described with respect to user device 102. For example, content creator device 104 may also incorporate one or more of the referenced components, elements, and/or capabilities. It should also be understood that certain aspects and implementations of various devices, systems, servers, services, etc., such as those depicted in FIG. 1A and/or described herein, are also described in greater detail below in relation to FIG. 3.

Content creator device 104 can be a rackmount server, a router computer, a personal computer, a portable digital assistant, a mobile phone, a laptop computer, a tablet computer, a camera, a video camera, a netbook, a desktop computer, a media center, a smartphone, a watch, a smartwatch, an in-vehicle computer/system, any combination of the above, or any other such computing device capable of implementing the various features described herein. Various applications, such as mobile applications (‘apps’), web browsers, etc. (not shown) may run on the content creator device (e.g., on the operating system of the content creator device). Moreover, in certain implementations content creator device 104 can interact with and/or provide instructions to server machine 120 and/or third-party content source 150, such as in order to generate and/or provide content (e.g., articles, calendar entries, social media posts, notifications, etc.) that can be delivered to user devices 102. It should be understood that, in certain implementations, content creator device 104 can also include and/or incorporate various sensors and/or communications interfaces (not shown). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc. It should be understood that, in certain implementations, content creator device 104 can also include and/or incorporate various sensors and/or communications interfaces (including but not limited to those depicted in FIG. 2 and described in relation to user device 102).

Server machine 120 can be a rackmount server, a router computer, a personal computer, a portable digital assistant, a mobile phone, a laptop computer, a tablet computer, a camera, a video camera, a netbook, a desktop computer, a smartphone, any combination of the above, or any other such computing device capable of implementing the various features described herein. Server machine 120 can include components such as content conversion engine 132, content enhancement engine 134, and data repository 140. The components can be combined together or separated in further components, according to a particular implementation. It should be noted that in some implementations, various components of server machine 120 may run on separate machines (for example, data repository 140 can be a separate device). Moreover, some operations of certain of the components are described in more detail below. It should be understood that, in certain implementations, server machine 120 can also include and/or incorporate various sensors and/or communications interfaces (including but not limited to those depicted in FIG. 2 and described in relation to user device 102).

Data repository 140 can be hosted by one or more storage devices, such as main memory, magnetic or optical storage based disks, tapes or hard drives, NAS, SAN, and so forth. In some implementations, data repository 140 can be a network-attached file server, while in other implementations data repository 140 can be some other type of persistent storage such as an object-oriented database, a relational database, and so forth, that may be hosted by the server machine 120 or one or more different machines coupled to the server machine 120 via the network 110, while in yet other implementations data repository 140 may be a database that is hosted by another entity and made accessible to server machine 120. Data repository 140 can store data such as may be received from content creator device 104 and/or generated by/in conjunction with content conversion engine 132 and/or content enhancement engine 134, such as in order to generate enhanced content (e.g., based on content provided by content creator device 104) and/or in order to generate such content in various formats (e.g., web, mobile, calendar, social media, etc., formats), such as is described herein.

Third-party content source 150 can be a rackmount server, a router computer, a personal computer, a portable digital assistant, a mobile phone, a laptop computer, a tablet computer, a camera, a video camera, a netbook, a desktop computer, a smartphone, any combination of the above, or any other such computing device capable of implementing the various features described herein. In certain implementations, third-party content source 150 can be one or more websites and/or any other such source(s) of information, such as may be accessed by server machine 120, e.g., in order to enhance the content received from content creator device 104, such as in a manner described herein.

As noted above (and as described in detail herein), server machine 120 can be configured to receive content from content creator device 104 (e.g., a blog post, etc.), and process such content (e.g., in conjunction with content conversion engine 132) in order to generate one or more instances/versions of such content in various formats (e.g., web format, mobile format, calendar format, social media format, etc.). Additionally, such content (whether as received from content creator device 104 and/or as converted into one or more formats) can be enhanced (e.g., in conjunction with content enhancement engine), such as in order to associate and/or incorporate various additional information items, metadata 162, etc., that may be associated with the content item (e.g., dates, times, locations, etc.), such as is described herein. In doing so, a single piece of content (e.g., as provided by content creator device 104) can be used to generate multiple content items in multiple formats, each of which can be provided to certain user device(s) 102, such as in a manner described herein.

It should be understood that though FIG. 1A depicts server machine 120, devices 102 and 104, and content source 150 as being discrete components, in various implementations any number of such components (and/or elements/functions thereof) can be combined, such as within a single component/system. For example, in certain implementations devices 102 and/or 104 can incorporate features of server machine 120. In another example, server machine 120 and service 150 can be combined into a single machine.

As described in detail herein, various technologies are disclosed that enable generating enhanced content. In certain implementations, such technologies can encompass operations performed by and/or m conjunction with content conversion engine 132 and/or content enhancement engine 134.

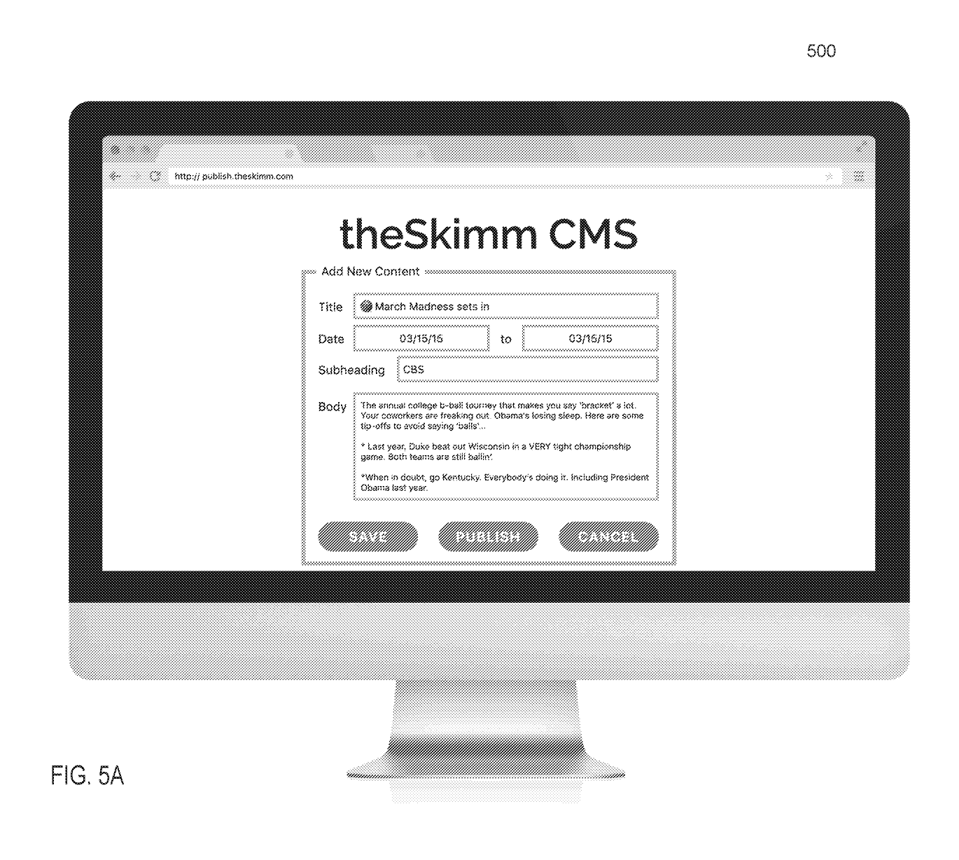

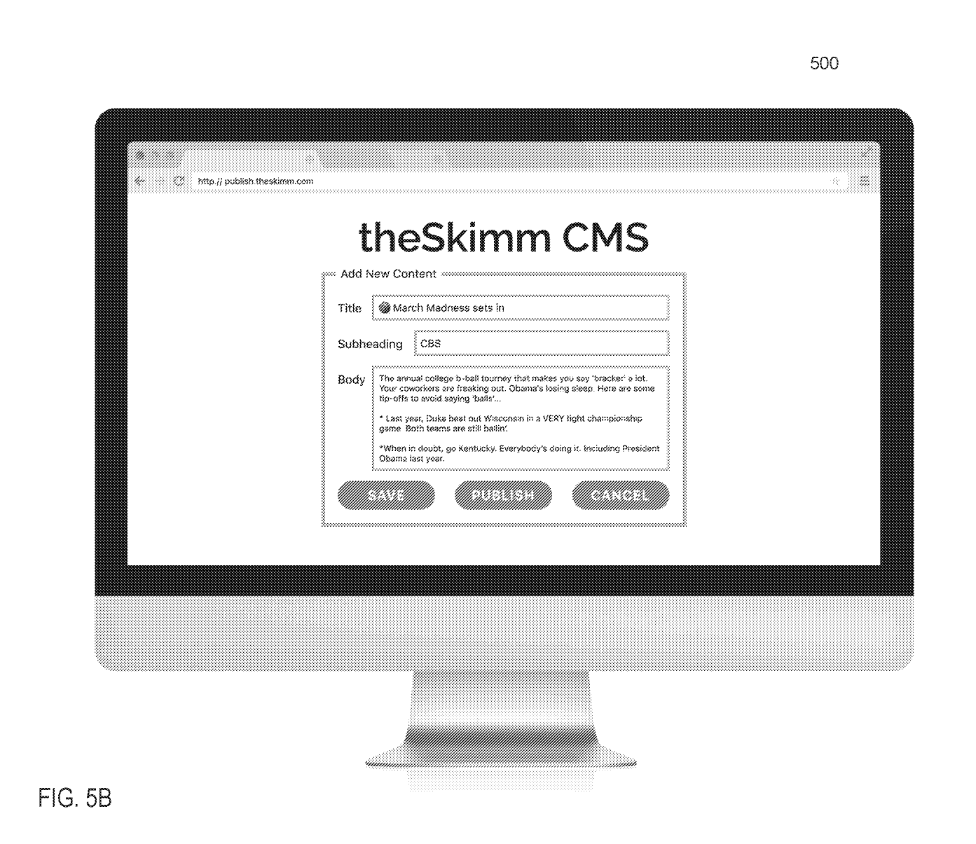

By way of illustration, FIG. 1B depicts an exemplary implementation of the described technologies. As shown in FIG. 1B, a content creator device 104 utilizing a content management tool 161 or content management system (CMS) can generate an initial piece of content. For example, FIG. 5A depicts an exemplary user interface 500, such as an interface of a CMS through which content creator device 104 can generate an initial content item, such as a blog post. As shown in FIG. 5A, content creator device 104 can provide various elements/parameters of such a content item, including but not limited to a title, a subheading, and a body of content (e.g., a news story). Additionally, in certain implementations various metadata items or parameters can also be provided by content creator device 104, e.g., the date(s), time(s), location(s), etc., associated with the content item (here, the date ‘3115115’). It should be understood that, in other implementations content creator device 104 may provide, for example, only the title and body of the content item (e.g., as depicted in FIG. 5B). It should be understood that, as described herein, various additional related information, metadata, etc., can be retrieved from third-part content sources, such as is described herein.

As further depicted in FIG. 1B, the received content (e.g., as provided by content creator device 104 via a CMS interface) can be enhanced in various ways. For example, upon receiving the initial content item (e.g., a blog post, article, etc.) from content creator device 104, such content item can be processed, parsed, etc. (e.g., using various language processing techniques/technologies). In doing so, various keywords and/or other identifiers associated with the content item can be identified. For example, the content item depicted in FIGS. 5A and 5B can be processed to determine that such content is related to ‘march madness,’ ‘basketball,’ college,’ etc.

Having identified such keywords, identifiers, etc. associated with the content item, various third-party content sources can be queried. For example, having identified that the content depicted in FIGS. 5A and 5B is associated with ‘march madness,’ etc., various content sources (e.g., the Internet, various other third-party content sources, etc.) can be searched. In doing so, various additional information/metadata that may be associated with the received content item (but which may not be present in the content item, as originally provided by content creator device 104) can be identified. For example, in a scenario in which a content item can be determined to pertain to a particular event (e.g., ‘march madness’), the referenced third-party content sources can be queried in order to identify further related information/metadata associated with such content (e.g., the date(s)/time(s) associated with the content, location(s) associated with the content, demographic(s) associated with the content, and/or other such metadata, e.g., tags, that reflect/correspond to further aspects of the content item).

As also depicted in FIG. 1B, the content as originally received (e.g., from content creator device 104) and/or the content as enhanced (e.g., based on information/metadata received from third-party content sources) can be stored, e.g., in a central content database 160 (e.g., data repository 140, as depicted in FIG. 1A).

Subsequently, the referenced content (e.g., the content as originally provided by content creator device 104 and/or as enhanced, e.g., by content enhancement engine 134) can be provided to various devices (e.g., user device 102) and/or services. In certain implementations, such content can be provided to the various device(s)/service(s) via one or more application program interfaces (APis). FIG. 1B depicts certain exemplary APis (e.g., a Web API 170, a calendar API 171, a social API 172, etc.), though it should be understood that any number of APis are possible. Each of the referenced APis can be configured to format the referenced content items in a manner that is compatible with a particular device, application, service, etc.

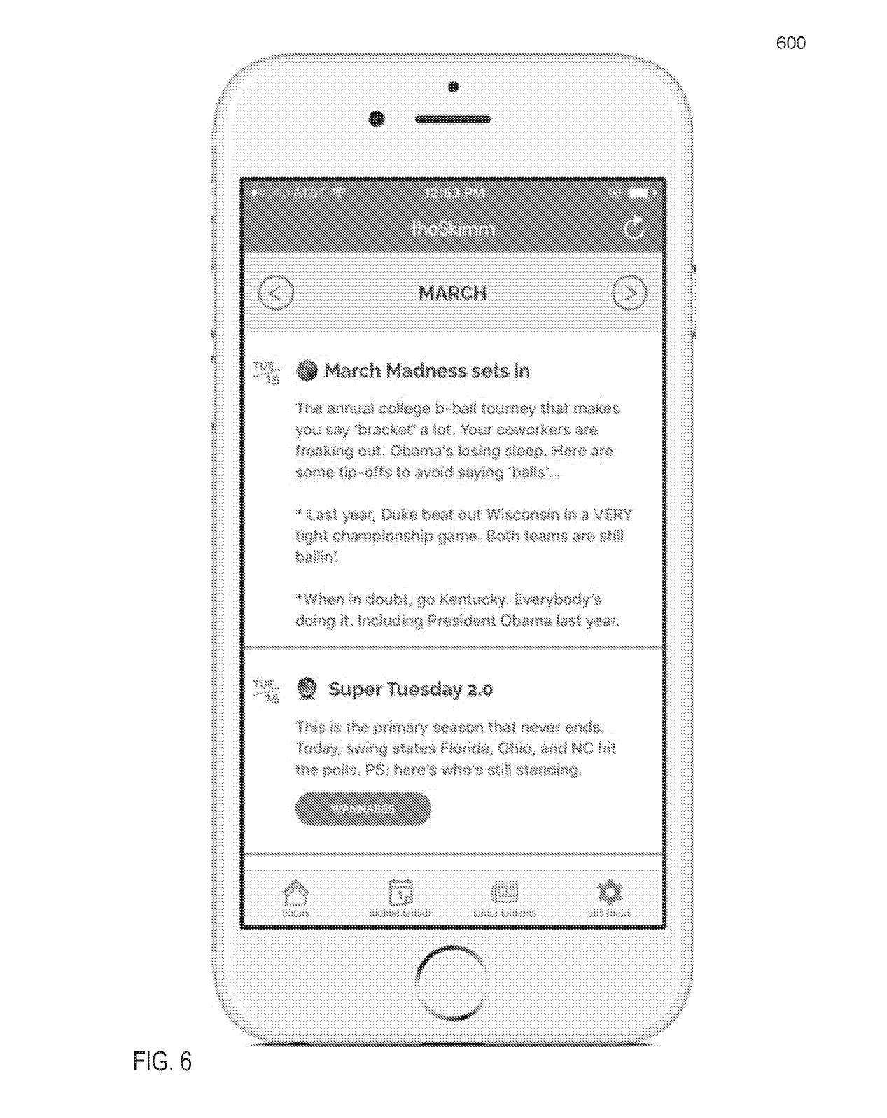

For example, a mobile/app API 173 can format a content item (together with the addition information/metadata with which it has been enhanced) for presentation within a mobile application 183 (e.g., in JSON format, and can further push the content to a mobile application to be rendered on the app). By way of illustration, FIG. 6 depicts an exemplary user interface 600 of a mobile application within which the referenced ‘march madness’ content item (that is, the content item originally provided via the CMS as depicted in FIGS. 5A and 5B) is presented.

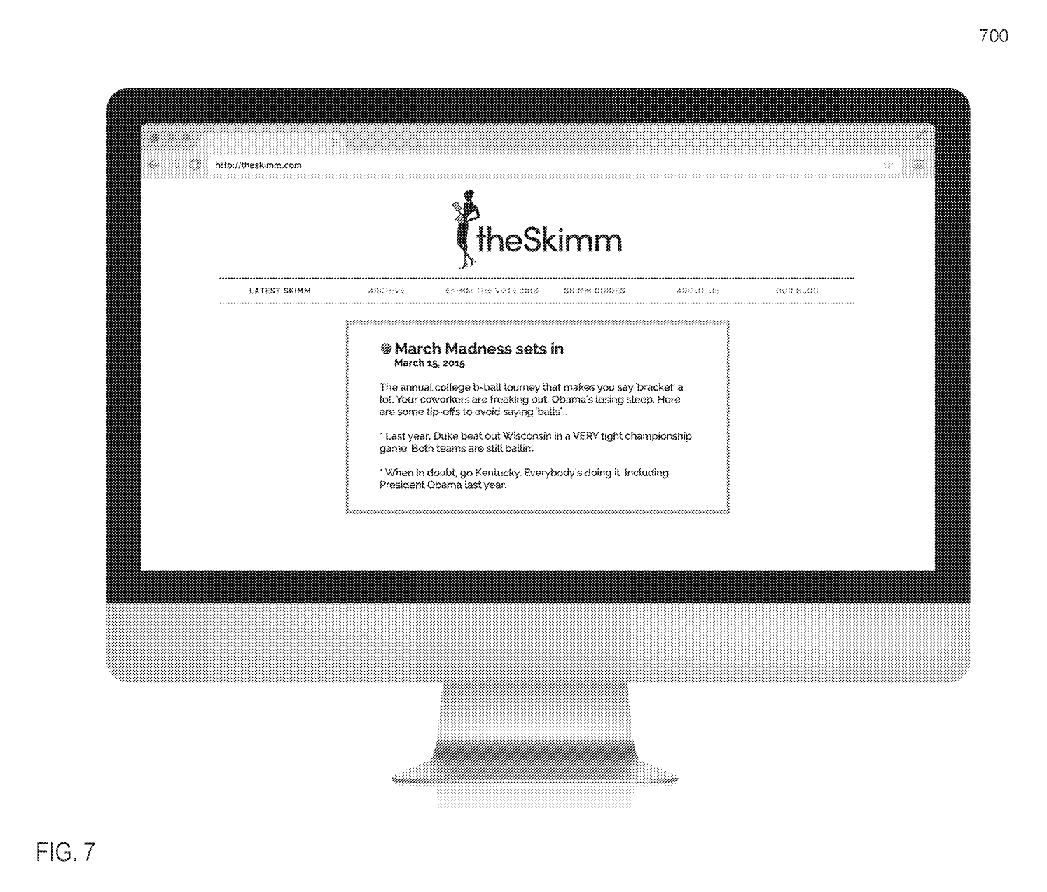

By way of further example, a web API 170 can format the content item (together with the addition information/metadata with which it has been enhanced) for presentation on a webpage 180 (e.g., in JSON format, and can further push the content to a webpage to be rendered on the site). FIG. 7 depicts an exemplary user interface 700 of a web browser within which the referenced ‘march madness’ content item (that is, the content item originally provided via the CMS as depicted in FIGS. 5A and 5B) is depicted within a webpage/blog post.

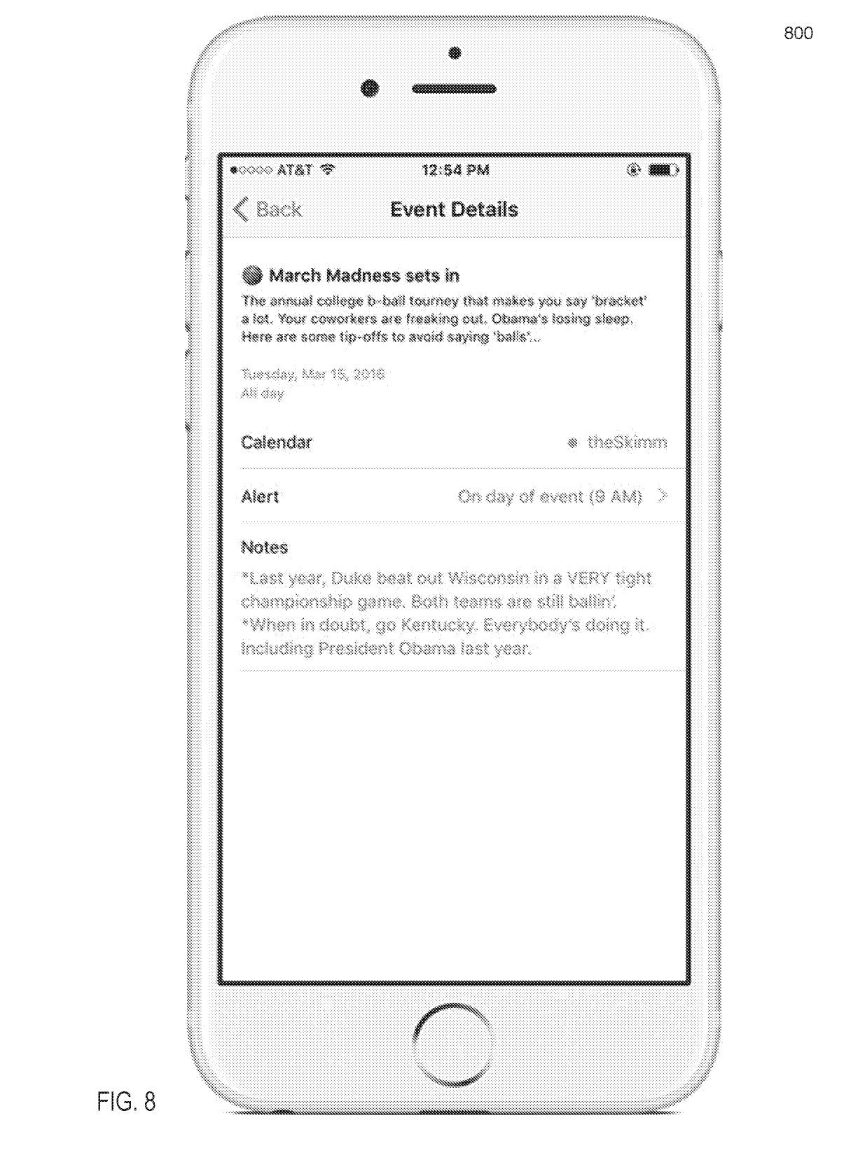

FIG. 8 depicts an exemplary example 800 of a calendar entry (e.g., calendar 181) that can be generated (e.g., using a calendar API 171) based on the content item and the addition information/metadata with which it has been enhanced. Such a content item can be formatted, for example, in webcal format and pushed to/rendered on a user's calendar. As shown in FIG. 8, the original content item (that is, the content item originally provided via the CMS as depicted in FIGS. 5A and 5B) can be formatted to account for the constraints and/or requirements of calendar presentation. For example, a portion of (and/or the entirety of) the original content item can be formatted for presentation within the ‘Notes’ section of the calendar entry. Additionally, an alert associated with the content item can be provided in the calendar entry.

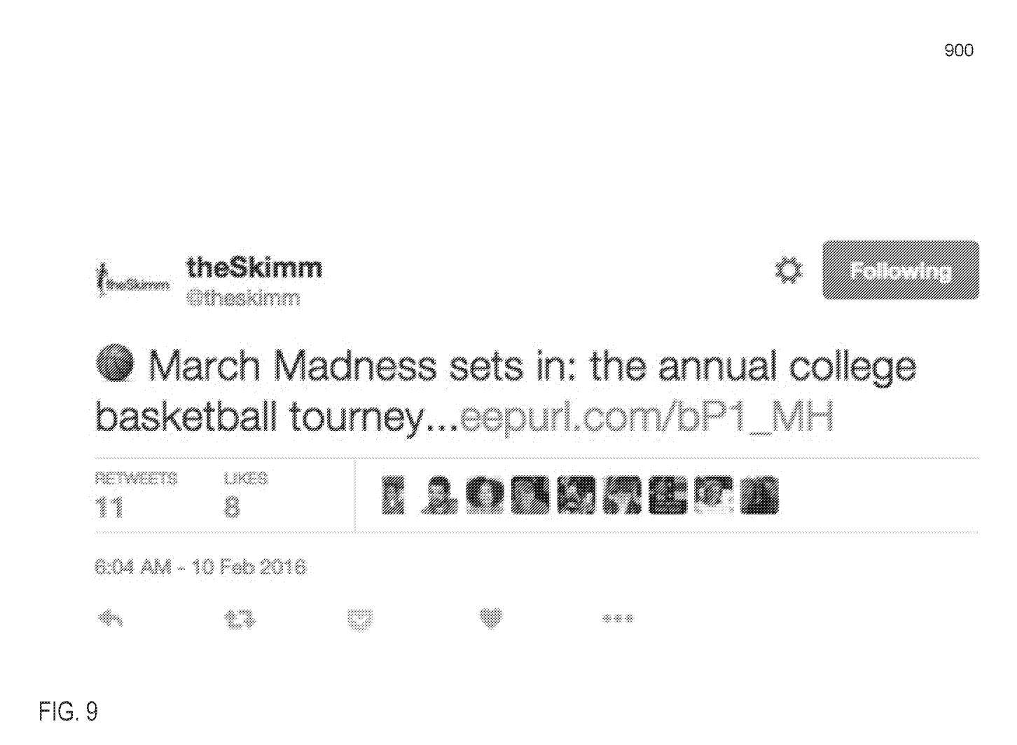

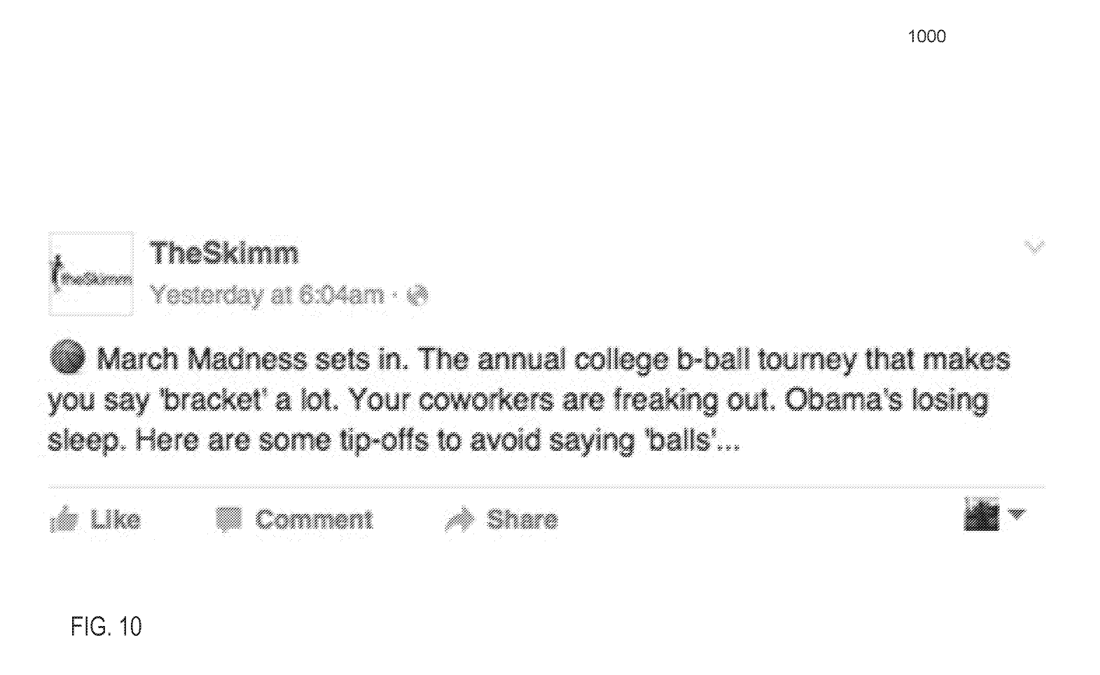

By way of yet further example, a social API 172 can format the content item (together with the addition information/metadata with which it has been enhanced) for presentation within various social media 182 contexts/settings. For example, FIG. 9 depicts an exemplary social media post 900 (here a ‘tweet’ as may be disseminated via the Twitter® social media service). As shown in FIG. 9, the original content item (that is, the content item originally provided via the CMS as depicted in FIGS. 5A and 5B) can be formatted (e.g., in JSON format, and can further be pushed via the Twitter API to be rendered on a Twitter feed) to account for the constraints and/or requirements of presentation within the referenced social media platform (e.g., the limitation on the number of characters). As also shown in FIG. 9, the content item can be further formatted to include a link, e.g., a link to the full content item (e.g., on a webpage and/or within a mobile application). As shown in FIG. 9, the original content item (that is, the content item originally provided via the CMS as depicted in FIGS. 5A and 5B) can be formatted into an enhanced post 1000 to account for the constraints and/or requirements of presentation within the referenced social media platform (e.g., the limitation on the number of characters). As also shown in FIG. 10 in certain implementations, the content item can be formatted with respect to other social media platforms (here, Facebook®) (e.g., in JSON format, and such content can further be pushed via the Facebook API to be rendered in a Facebook feed).

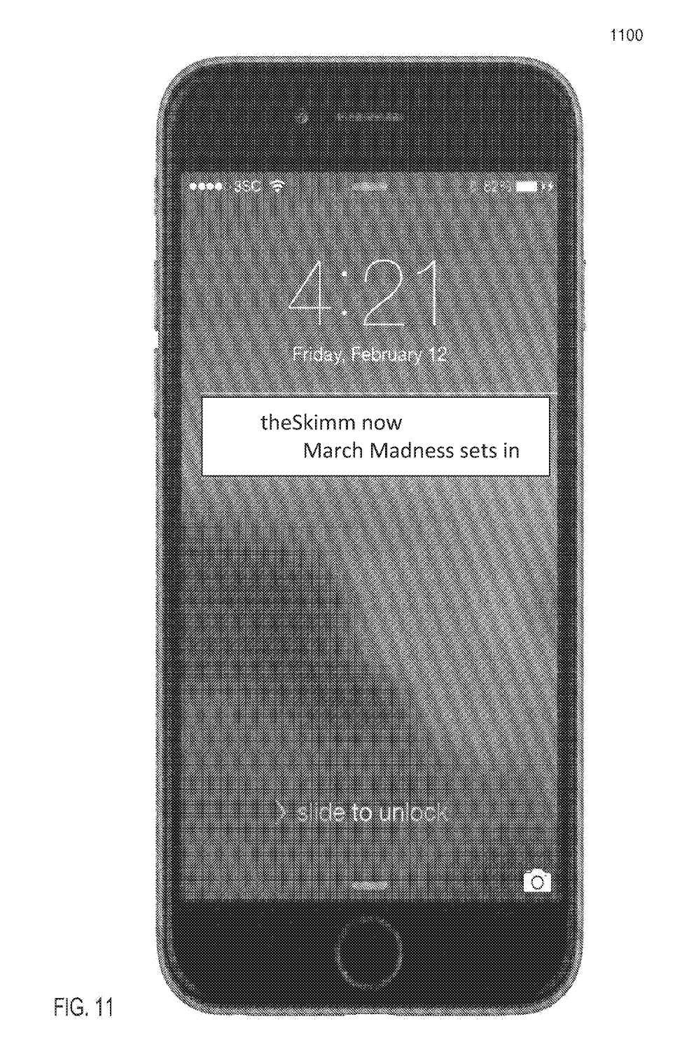

FIG. 11 depicts an exemplary notification 110 (such as notification 184) can be generated (e.g., using a notification API 174) based on the content item and the addition information/metadata with which it has enhanced. As shown in FIG. 11, the original content item (that is, the content item originally provided via the CMS as depicted in FIGS. 5A and 5B) can be formatted to account for the constraints and/or requirements of notification presentation (e.g., in JSON format and can further be pushed to APNS to be rendered as a push notification on user device 102). For example, a portion of the original content item (here, ‘March Madness sets in’) can be selected for presentation as a notification (e.g., on a mobile device).

It should be further understood that, in certain implementations, the various enhanced content items (e.g., as formatted based on various APis, such as in a manner described herein) can be delivered to different devices/users (e.g., user device 102) based on various characteristics, contexts, etc. that may be determined with respect to such devices/users. By way of illustration, it can be appreciated that certain types of content items (e.g., calendar entries, notifications, etc.) may be relatively more relevant to and/or of interest to certain users while being relatively less relevant to other users. For example, a user determined to be within a certain proximity of a location of a basketball game that is part of ‘March Madness’ may wish to be informed/notified (e.g., via a calendar entry, notification, etc.) of the specific timing (and/or location, etc.) of such a game. In contrast, another user (e.g., a user not determined to be within a proximity of such a game) may be provided such content in other formats (e.g., via a mobile application, such as in conjunction with the described mobile API). It can be appreciated that in doing so, the same content (that is, the same original content as provided by a content creator) can be formatted in multiple ways and delivered to different users in different respective formats, based on, for example, a determination as to the relevance of a particular format to a particular user (e.g., based on characteristics, location, etc. of such a user).

It should be further understood that, in certain implementations, the described characteristics, etc., of a user/device can be determined based on one or more inputs received from sensors of the user device (such as those described and/or referenced herein, e.g., in relation to FIG. 2). For example, based on inputs received from a GPS receiver of such a device, the location of a user can be determined. Based on such a location, notifications, calendar entries, etc., that are relevant to such a user can be transmitted to such a user/device, while other notifications/entries that are relevant to other locations may not necessarily be transmitted to such a device. In doing so, content can be transmitted to a particular user in a manner determined to be likely to be relevant/of interest to such a user.

Additionally, it can be appreciated that in certain circumstances, multiple content items of the same format can be generated based on a single content item. For example, in certain implementations the described original ‘march madness’ content item can be converted into multiple calendar entries: e.g., one calendar entry that corresponds to the television schedule associated with ‘march madness’ and another entry that corresponds to a live action schedule of ‘march madness.’ In such a scenario, the television-centric calendar entry can include further information (as obtained from various third-party content sources, as described herein) such as the channel(s) on which various games are being broadcast, the time(s) and lineups of such games, links to streaming broadcasts, etc. In contrast, the live action-centric calendar entry can include further information (as obtained from various third-party content sources, as described herein) such as the location(s) at which of local games are being played, the time(s) and lineups of such games, links to purchase tickets, etc. As described above, the referenced ‘live action’ calendar entry can be delivered to users determined to be within a certain proximity of such an event, while the ‘television/broadcast’ calendar entry can be delivered to users not within such a proximity of the live game. In doing so, a single content item can be converted into multiple instances in a single format, and such respective instances can be delivered to different users based on their determined relevance to a particular content item.

It should be understood that the above described scenarios are exemplary and that the described technologies can be similarly implemented with respect to other content formats as well. For example, different notifications can be generated and provided to different users, e.g., based on such users characteristics, location, etc. For example, a notification that a certain team has won a game can be provided to one user while not being provided to another user (e.g., a user determined to be present at the game itself).

Various aspects of the technologies described herein include one or more methods, such as those described herein. The method is performed by processing logic that may comprise hardware (circuitry, dedicated logic, etc.), software (such as is run on a computing device such as those described herein), or a combination of both. For simplicity of explanation, methods are described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

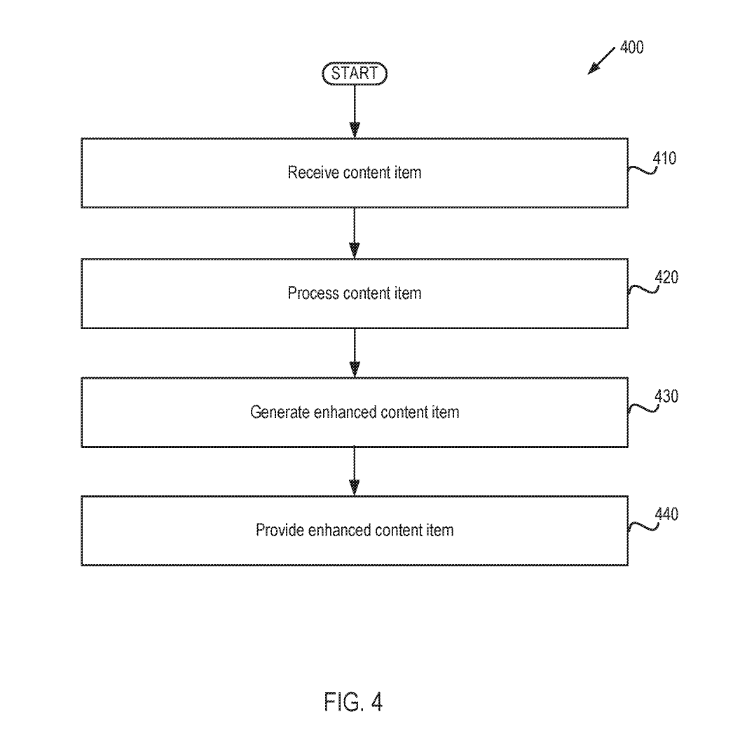

For example, FIG. 4 depicts an exemplary flow diagram showing a method of generating enhanced content, such as is described herein.

At block 410, a content item (e.g., a blog post, etc.) can be received. In certain implementations, such a content item can be received from a content creator, such as via a CMS tool. It should be understood that, in certain implementations, various aspects of block 410 can be performed by content conversion engine 132 and/or server machine 120, while in other implementations such aspects may be performed by one or more other elements/components, such as those described herein.

At block 420, the content item can be processed. In doing so, content relevant to the content item can be retrieved, e.g., from a third-party content source (e.g., the Internet, another third-party source, etc.), such as in a manner described herein. It should be understood that, in certain implementations, various aspects of block 420 can be performed by content enhancement engine 134 and/or server machine 120, while in other implementations such aspects may be performed by one or more other elements/components, such as those described herein.

At block 430, one or more enhanced content items can be generated. In certain implementations, such enhanced content items can be generated based on the content item and the content relevant to the content item, such as in a manner described herein. It should be understood that, in certain implementations, various aspects of block 430 can be performed by content conversion engine 132 and/or server machine 120, while in other implementations such aspects may be performed by one or more other elements/components, such as those described herein.

At block 440, at least one of the one or more enhanced content items can be provided, e.g., to a user device. In certain implementations, such enhanced content items can be provided based on one or more characteristics of the user device. It should be understood that, in certain implementations, various aspects of block 410 can be performed by content conversion engine 132 and/or server machine 120, while in other implementations such aspects may be performed by one or more other elements/components, such as those described herein.

It should be noted that though much of the forgoing description is directed to implementations pertaining to generating enhanced content, the scope of the present disclosure is not so limited. Accordingly, it should be understood that the technologies described herein can be similarly implemented in any number of other settings and/or contexts. It should be understood that further technical advantages, solutions, and/or improvements (beyond those described and/or referenced herein) may also be enabled as a result of such implementations.

FIG. 3 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a personal computer (PC), a mobile or tablet computer, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 600 includes a processing system (processor) 602, a main memory 604 (e.g., read-only memory (ROM), flash memory, dynamic random access memory (DRAM) such as synchronous DRAM (SDRAM)), a static memory 606 (e.g., flash memory, static random access memory (SRAM)), and a data storage device 616, which communicate with each other via a bus 608.

Processor 602 represents one or more processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 616 may include a computer-readable medium 624 on which is stored one or more sets of instructions 626 which may embody any one or more of the methodologies or functions described herein. Instructions 626 may also reside, completely or at least partially, within the main memory 604 and/or within the processor 602 during execution thereof by the computer system 600, the main memory 604 and the processor 602 also constituting computer-readable media. Instructions 626 may further be transmitted or received over a network via the network interface device 622.

While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing,” “receiving,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. In certain implementations, this apparatus may be specially constructed for the required purposes. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It should be understood that the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving a content item;
processing, by a processing device, the content item to retrieve content relevant to the content item from a third-party content source;
generating, by the processing device, one or more enhanced content items based on the content item and the retrieve content relevant to the content item; and
providing, by the processing device, at least one of the one or more enhanced content items to a user device based on one or more characteristics of the user device.

2. The method of claim 1, further comprising crawling for web content of a third-party content source provider based on the content item.

3. The method of claim 1, wherein the content item is an online post of a user.

4. The method of claim 1, wherein the generating further comprises converting the retrieve content into multiple formats for distribution to client device.

5. The method of claim 4, wherein the multiple formats comprising at least one of a: web format, mobile format, social media format, notification format, messaging format and a calendar format.

6. The method of claim 1, wherein the content item is an online post of a user regarding an event.

7. The method of claim 6, wherein the generating further comprises:
crawling for web content associated with the event; and
modifying metadata of the enhanced content items with the web content.

8. A system comprising:
a memory; and
a processing device, operatively coupled to the memory, to:
receive a content item;
process the content item to retrieve content relevant to the content item from a third-party content source;
generate one or more enhanced content items based on the content item and the retrieved content relevant to the content item; and
provide at least one of the one or more enhanced content items to a user device based on one or more characteristics of the user device.

9. The system of claim 8, wherein the processing device is further to crawl for web content of a third-party content source provider based on the content item.

10. The system of claim 8, wherein the content item is an online post of a user.

11. The system of claim 8, wherein to generate, the processing device is further to convert the retrieve content into multiple formats for distribution to client device.

12. The system of claim 11, wherein the multiple formats comprising at least one of a: web format, mobile format, social media format, notification format, messaging format and a calendar format.

13. The system of claim 8, wherein the content item is an online post of a user regarding an event.

14. The system of claim 13, wherein to generate, the processing device is further to:
crawl for web content associated with the event; and
modify metadata of the enhanced content items with the web content.

15. A non-transitory computer readable medium having instructions stored thereon that, when executed by a processing device, cause the processing device to:
receive a content item;
process the content item to retrieve content relevant to the content item from a third-party content source;
generate, by the processing device, one or more enhanced content items based on the content item and the retrieved content relevant to the content item; and
provide at least one of the one or more enhanced content items to a user device based on one or more characteristics of the user device.

16. The non-transitory computer readable medium of claim 15, wherein the processing device is further to crawl for web content of a third-party content source provider based on the content item.

17. The non-transitory computer readable medium of claim 15, wherein to generate, the processing device is further to convert the retrieve content into multiple formats for distribution to client device.

18. The non-transitory computer readable medium of claim 17, wherein the multiple formats comprising at least one of a: web format, mobile format, social media format, notification format, messaging format and a calendar format.

19. The non-transitory computer readable medium of claim 15, wherein the content item is an online post of a user regarding an event.

20. The non-transitory computer readable medium of claim 19, wherein to generate, the processing device is further to:
crawl for web content associated with the event; and
modify metadata of the enhanced content items with the web content.
